(19) United States
(12) Patent Application Publication
(10) Pub. No.: US 2006/0010051 A1
(43) Pub. Date: Jan. 12, 2006

(54) Method and system for time sheet reporting

(75) Inventors: Juergen Sattler, Wiesloch (DE); Joachim Gaffga, Wiesloch (DE)

Correspondence Address: KENYON & KENYON, 1500 K STREET NW, SUITE 700, WASHINGTON, DC, 20005, US

(73) Assignee: SAP Aktiengeseilschaft

(21) Appl. No.: 11/105,386

(22) Filed: Apr. 14, 2005

Related U.S. Application Data
(60) Provisional application No. 60/585,597, filed on Jul. 7, 2004.
(60) Provisional application No. 60/623,869, filed on Nov. 2, 2004.

(51) Int. Cl. G06Q 99/00

(52) U.S. Cl. 705/32

(57) ABSTRACT

A method and system for time sheet reporting is provided. A draft electronic time sheet report may be generated for an employee. A query may be generated to obtain information, from a data records associated with different software applications, about activities performed by the employee during a reporting period. An amount of employee time associated with these activities may be calculated from the information obtained, and the electronic time sheet report may be prepopulated to include information obtained about the employee's activities and the amount of time spent on those activities. The prepopulated time sheet report may be transmitted to the employee by electronic mail.

### BACKGROUND

Employee time reporting may be used for a business to record an employee's work performed, for example in order to bill customers for the work performed on particular tasks. Traditionally, time reporting has been done manually. For example, an employee may manually keep track of the employee's work and time spent on the work and may submit a written report, which may then be manually compiled with other time reports.

Systems have been created that an employee may use to submit data for the employee's time report. However, the employee must still manually enter most of the data regarding the employee's work and time into the system. Accordingly, there is a need in the art for a quick, efficient time reporting system.

### BRIEF DESCRIPTION OF DRAWINGS

FIG. 1 is a data flow diagram that depicts a process for generating a time sheet report according to an embodiment of the invention.

FIG. 2 is a data flow diagram that depicts a process for generating and posting a time sheet report according to a further embodiment of the invention.

FIG. 3 is a block diagram that shows an overview of a system for time sheet reporting according to an embodiment of the present invention.

FIG. 4 is a block diagram that shows examples of different stages of time sheet reports that were generated according to an embodiment of the present invention.

FIG. 5 is a block diagram that shows additional examples of different stages of time sheet reports that were generated according to an embodiment of the present invention.

FIG. 6 is a flowchart diagram of a method for generating a time sheet according to an embodiment of the present invention.

### DETAILED DESCRIPTION OF EMBODIMENTS

Embodiments of the present invention are directed to a method and system for time sheet reporting. These embodiments advantageously provide an automated system and method for generating, prepopulating and monitoring an employee's time sheet reports. The method may include automatically retrieving a list of the employee's activities and the time spent on these activities for a reporting period, and prepopulating the employee's time sheet report with the retrieved data. As used herein, an “activity” is something that the employee takes part in or does, such as drafting a paper, making a phone call, attending a meeting or class, reading a document, traveling to a location, etc. The method may further include allowing the employee to modify the prepopulated time sheet report, and may include monitoring the employee's posting of the completed time sheet to a time sheet database. It may be understood that the examples discussed below are for illustration purposes only and are not intended to limit the configuration to that shown.

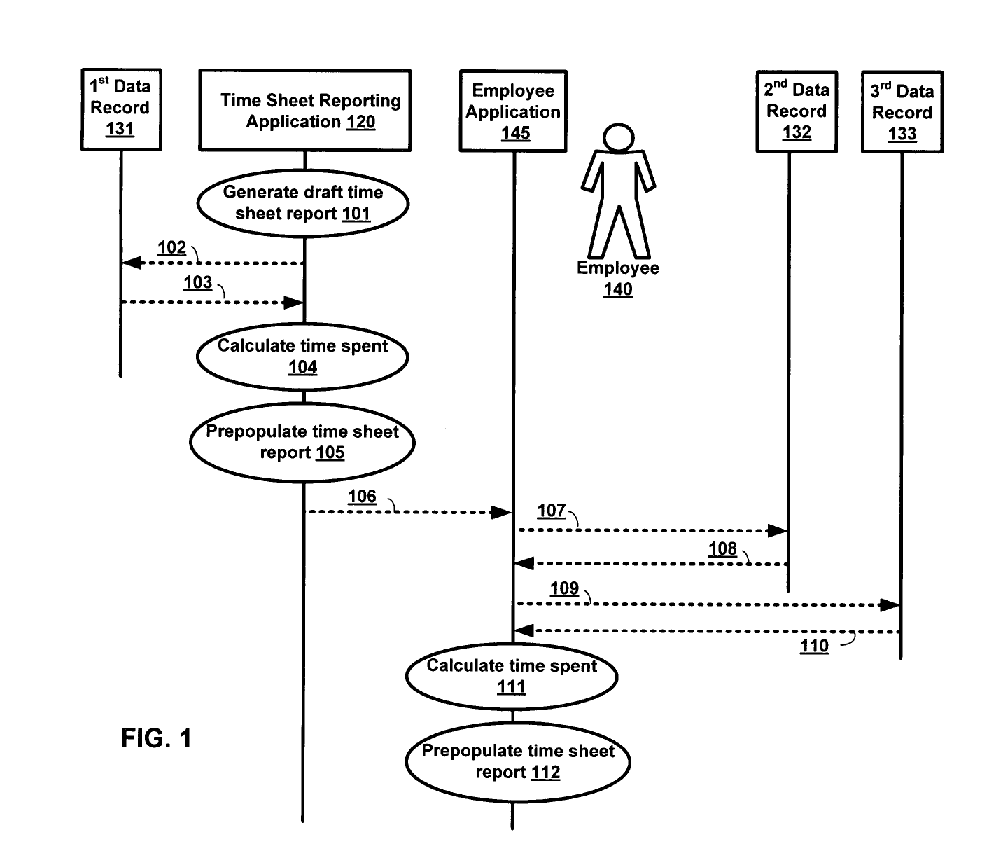

FIG. 1 is a data flow diagram that depicts a process for generating a time sheet report according to an embodiment of the invention. FIG. 1 shows a time sheet reporting application 120, a set of data records 131-133, an employee 140, and an employee application 145. Time sheet reporting application 120 is a software application for generating time sheet reports that is executing on a computer device. Employee 140 is an employee in an organization whose time sheet is to be generated. Employee 140 has a computer device, which may be the same computer device that is executing time sheet reporting application 120 or, more typically, may be a different computer device. Employee application 145 is an interface that employee 140 uses to receive and send communications and perform other actions relating to time reporting functions, and may include the UI and supporting associated software for an email application, a spreadsheet application, etc. Data records 131-133 are stored in data files and are associated with employee 140. An example, as discussed below, is a record created by an appointment calendar program that records an appointment for employee 140.

In operation, time sheet reporting application 120 first generates a draft time sheet report (101) as an electronic document, such as a word processor file, a spreadsheet file, etc. At this point, the draft time sheet report would typically not contain any data, other than data identifying the employee (e.g., name, etc.) and data reflecting the days that are to be reported on. A query may then be generated by the time sheet reporting application to obtain information about activities performed by the employee during the relevant reporting period from a plurality of data records associated with different software applications. The software applications may be any types of software that perform functions and which may generate, store or otherwise use data that reflects activities performed by the employee. In the example discussed below, first data record 131 may be a record created in a training database management software application that records details of a training class to be attended by employee 140.

The activities recorded in data records 131-133 may be the type of information that is to be recorded on the employee's time sheet, and thus an attempt may be made to extract the relevant information from these data records. As shown in FIG. 1, time sheet reporting application 120 may generate a query (102) to extract any relevant information from first data record 131, which information may then be returned to time sheet reporting application 120 (103). For example, a training database file may be searched for entries associated with employee 140 that are in a relevant time period, and data record 131 may be identified as having such relevant information. Information may be extracted from data record 131 and sent back to time sheet reporting application 120. After obtaining relevant information for one or more activities of employee 140 from the application data records, time sheet reporting application 120 may then calculate an amount of time that the employee spent on each activity from the information extracted (104). For example, if the activity was a training class from 9:00 AM to 5:00 PM, the amount of time spent may be calculated as 8 hours. Time sheet reporting application 120 may then prepopulate the electronic time sheet report to include the information obtained about the employee's activities and the amount of time spent on those activities (105). The prepopulated time sheet report may then be transmitted to employee 140 by electronic mail or “email” (106).

In some embodiments, an employee may have the ability to cause the further prepopulation of the draft time sheet application 106, for example from data records that are resident on the computer or LAN associated with that employee. In such embodiments, employee 104's user interface (e.g., for a spreadsheet application program) may provide functionality that generates queries to additional data records. As shown in FIG. 1, employee application 145 may generate queries (107 and 109) to extract any relevant information from second data record 132 and third data record 133, which information may then be returned to employee application 145 (108 and 110). As discussed above, employee application 145 may then calculate an amount of time that the employee spent on each activity from the information extracted (111) and may further prepopulate the electronic time sheet report to include the information obtained about the employee's activities and the amount of time spent on those activities (112).

In embodiments, time sheet reporting application 120 and employee application 145 do not direct queries at any specific data records, but rather the queries may be directed at a database or set of data records (e.g., calendar application data). Although this example shows three queries, any number of queries to different databases may be made. In some cases, even though one or more queries may have been made, time sheet reporting application 120 and/or employee application 145 may have been unable to obtain any relevant information from the application data records.

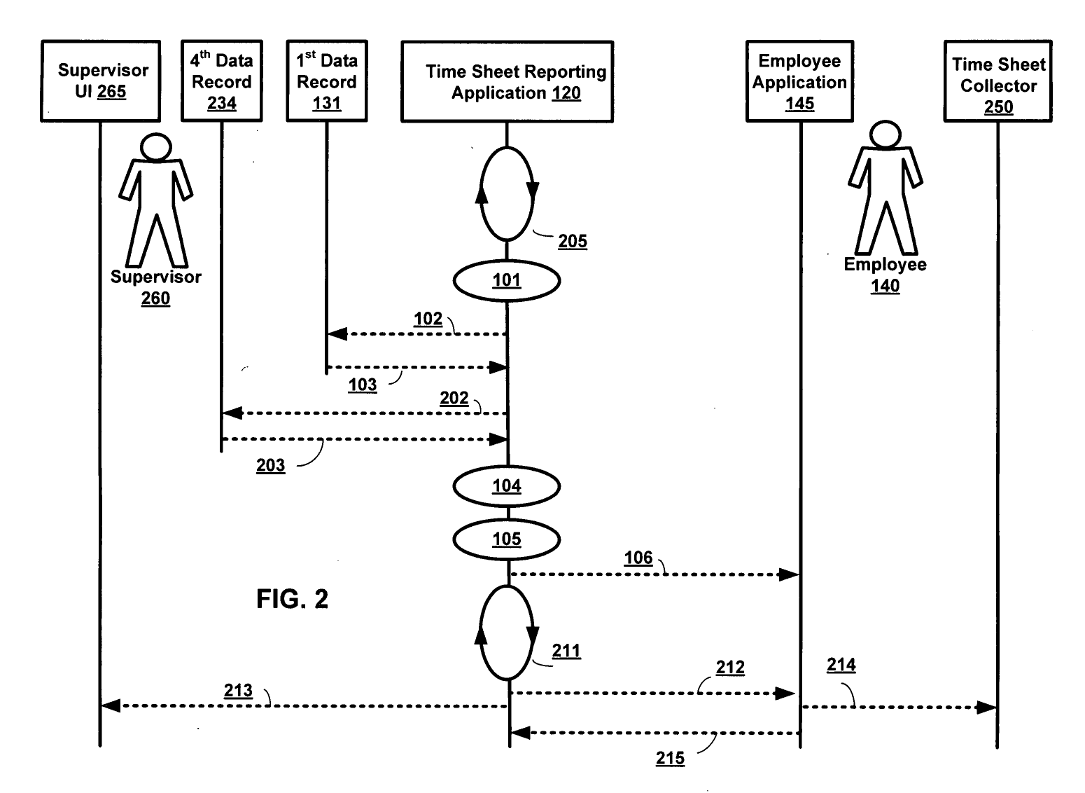

FIG. 2 is a data flow diagram that depicts a process for generating and posting a time sheet report according to a further embodiment of the invention. FIG. 2 is substantially similar to FIG. 1. However, FIG. 2 also shows a time sheet collector 250, which may be a time sheet processing application and/or a database that receives completed electronic time sheets and performs accounting and/or other functions based upon the data contained therein. FIG. 2 also shows employee's supervisor 260, who would typically be associated with a computer device, and a supervisor UI 265, through which the supervisor may receive and send communications. As compared to FIG. 1, FIG. 2 only shows two data records (131 and a fourth data record 234), but FIG. 2 shows a number of additional operations and data flows (205 and 211-215) that may be performed.

FIG. 2 shows a loop 205 in which time sheet reporting application 120 may determine whether it is appropriate for an employee to submit a time sheet for a reporting period. If so, a draft time sheet report may be generated (101) as shown in FIG. 1. FIG. 2 then proceeds as in FIG. 1 until the prepopulated time sheet report is transmitted to employee 140 by electronic mail (106), although in this example two data records (131 and 234) are polled (102-103 and 202-203). After waiting a period of time (211) after transmitting the prepopulated time sheet report to the employee, the time sheet reporting application 120 may determine whether the employee 140 has transmitted back a notification indicating that the employee 140 has posted the time sheet report to the time sheet collector 250. If not, then as shown in this example time sheet reporting application 120 may send a reminder to the employee indicating that the notification of posting has not yet been received (212). In some embodiments, where such a notification has not been received after waiting a first time period, time sheet reporting application 120 may also send a notification of non-receipt to the employee's supervisor 260 (213). In some embodiments, time sheet reporting application 120 may wait a second time period after sending the reminder to the employee 140 before sending a notification to the employee's supervisor 260. After receiving the reminder, the employee might post the time sheet (214) to the time sheet collector and send a notification of such posting (215) to the time sheet reporting application. In embodiments, some or all of these reminders, notifications and postings may be transmitted by electronic mail. If the communications are via electronic mail, then the process may take place even when the employee is off-line (i.e., not connected to the computer system.)

An employee would typically make modifications to the received time sheet before posting the time sheet because the information extracted from the data records and included in the time sheet would likely be incomplete. For example, the activity description may be incomplete or inaccurate, the recorded time spent by the employee on that activity may be inaccurate, activities may have been left off even though they were performed, and/or activities may have may have been included even though not actually performed. This would not be uncommon because the data was automatically extracted without any human intervention. An employee's electronic calendar, for example, might not be maintained with as much care is required of an employee's time sheet. Even though the employee may need to make corrections of the time sheet report, it would likely be less work for the employee than starting from scratch. The time sheet may also require specifying a particular client and/or task (such as by task number), which information may not be present in the data records. In some embodiments, in addition to querying a data record associated with a software application for information about activities, time sheet reporting program 120 may also prepopulate a time sheet report with information from a previous time sheet report for this employee, such as from an earlier reporting period.

In some embodiments, the employee 140 may send back a copy of the modified data record to the time sheet reporting application, in which case the time sheet reporting application may then improve the accuracy of future time sheets based on the information that was modified. In some embodiments, rather than the employee 140 posting the time sheet report to the time sheet collector 250, the employee 140 returns the finalized time sheet report (e.g., by email) to the time sheet reporting program 120, which sends the time sheet report to the time sheet collector 250. In another embodiment, the employee 140 posts the time sheet report to the time sheet collector 250, but the time sheet collector 250 sends the acknowledgement notification to the time sheet reporting application 120 (rather than the employee sending this acknowledgement notification). In some embodiments, rather than the employee posting the time sheet report by sending an email, the time sheet report may be posted by any other known method for submitting data.

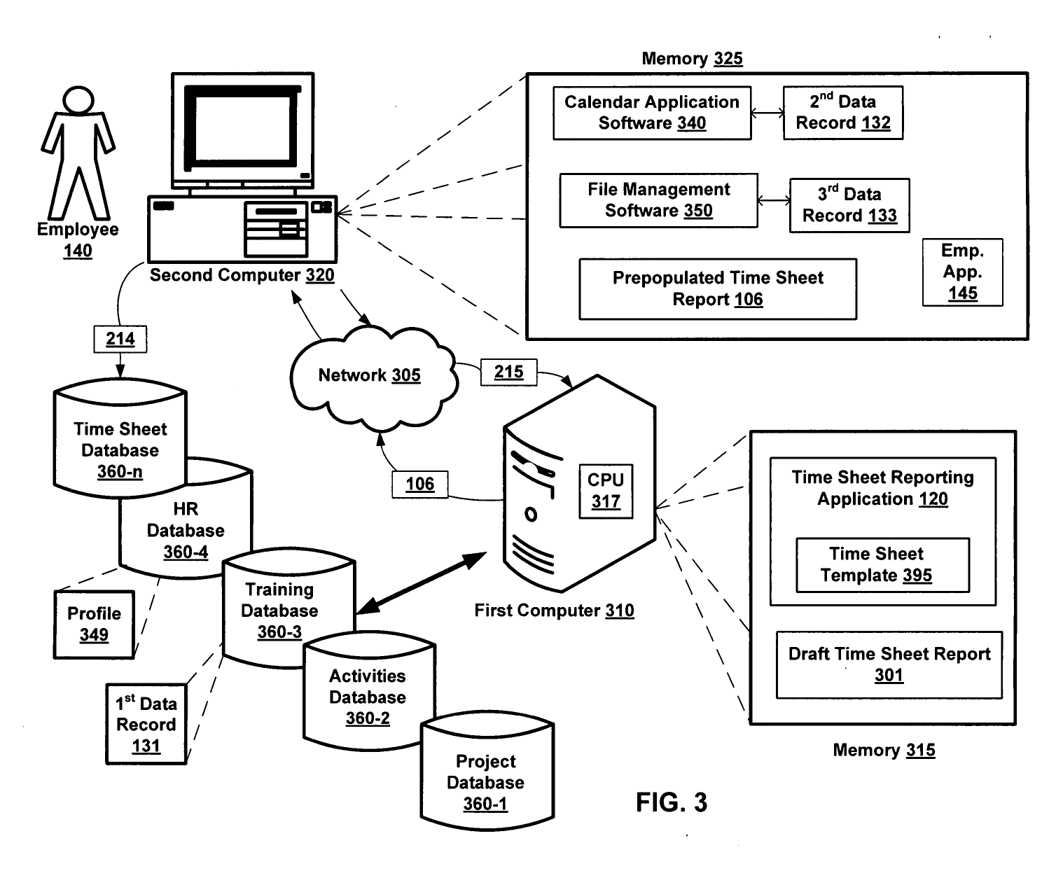

FIG. 3 is a block diagram that shows an overview of a system for time sheet reporting according to an embodiment of the present invention. In this example, a first computer 310 is coupled to a second computer 320 and to one or more databases 360 by network 305, which may be any type of network, such as the Internet, an intranet, a Wide Area Network (WAN), local area network, etc. FIG. 3 also shows employee 140 of FIGS. 1-2, here associated with second computer 320. First computer 310 and second computer 320 may be any computer devices, such as a personal computer or a personal digital assistant. First computer 310 is typically a server device and may be a group of servers that perform operations for second computer 320 or for a group of computers such as second computer 320. In typical embodiments, second computer 320 is a part of a local area network (LAN) of computers, and second computer 320 communicates with other devices (such as first computer 310) through the LAN. In some embodiments, first computer 310 may be implemented as separate components, and parts of the functionality may be performed on components residing on different networks.

As shown in FIG. 3, first computer 310 includes memory 315 and a central processing unit (CPU) 317. Memory 315 may be a machine readable medium that is capable of being read by a machine, such as a compact disk, hard drive memory, floppy disk memory, DVD-ROM, CD-ROM or any type of machine-readable (computer-readable) storing medium. Instructions stored on memory 315 may be included within a computer program (which as is well known comprises a plurality of instructions) that is executable by a processor. In the embodiment shown, memory 315 stores time sheet reporting application 120, which as discussed above may be a software application for generating time sheets. Memory 315 is also shown storing a time sheet template 395, which may be part of time sheet reporting application 120, and a draft time sheet report 301. In some embodiments, time sheet reporting application 120 may use time sheet template 395 to create a new draft time sheet 301, such as shown by the generate draft time sheet report operation 101 in FIGS. 1-2.

Databases 360-1 through 360-n may include sources from which to retrieve data regarding the employee's activities. As shown, database 360 includes a project database 360-1, which may include the employee's activities for a particular project, an activities database 360-2, which may include the employee's activities that are not associated with a particular project, training database 360-3, which may include information about employee training programs, and human resources (HR) database 360-4, which may contain information about employees that is maintained by a human resources department. Databases 360 may be part of a system such as a customer relationship management system (CRM), enterprise resource planning system (ERP), etc. Databases 360 are also shown as including a time sheet database 360-n, which may store the employee's completed time sheets. In some embodiments, time sheet database 360-n is used by time sheet collector 250 of FIG. 2 to store completed time sheets.

In some embodiments, time sheet reporting application 120 may prepopulate a time sheet report with information about employee activities that is stored in one or more of databases 360. In some embodiments, the draft time sheet report 301 may be an active form that contains fields which are supported by Web services, which are known to persons of skill in the art to allow for collection of information from different types of computer systems that may be connected by a network, such as an intranet or the Internet, by making calls to those systems. In some embodiments, during the generation of a time sheet report for employee 140, time sheet reporting application 120 may query a first database (such as HR database 360-4) and obtain information from a record that is stored in that database and is associated with employee 140 (such as profile 349) to determine which databases are likely to contain information to be used in prepopulating employee 140's time sheet. Such profile information may be stored for individuals employees or, more likely, for a class of employees. For example, employee 140 may be an employee who frequently undergoes training, and thus it may be likely that training database 360-3 contains relevant information. Accordingly, time sheet reporting application 120 may generate a query to training database 360-3 to obtain information (if any is available) from first data record 131 about training activities of employee 140 during the relevant reporting period.

As noted above, second computer 320 may be the personal computer of employee 140. As shown in FIG. 3, second computer 320 includes a memory 325, which may be a computer readable medium such as memory 315. Memory 325 is shown storing calendar application software 340, file management software 350, prepopulated time sheet report 106, second data record 132 and third data record 133 of FIG. 1. Time sheet reporting application 120 might send prepopulated time sheet report 106 to employee 140, who may open time sheet report 106 in employee application 145, causing prepopulated time sheet report 106 to be stored in memory 325. Employee application 145 may further prepopulate the time sheet report based on data records stored locally or that are accessible by employee application 145, such as second data record 132 and third data record 133, as discussed below. In some embodiments, employee application 145 may be a generalized application program (such as a spreadsheet application program) that executes a macro or other similar set of instructions that performs specific timesheet reporting functions, such as the operations for 107-112 shown in FIG. 1. Such instructions may be previously loaded into employee application 145 or may be sent from time sheet application 120 along with prepopulated time sheet 106. For example, a set of computer instructions may be written to look in the calendar application data file (which may have a known file structure and file identifier), to search that data file for relevant information, and to prepopulate the time sheet with any information found.

Calendar application software 340 may be a software application that is used by employee 140 to keep track of appointments (e.g., Microsoft Outlook®) and as shown here is associated with second data record 132. That is, second data record 132 may be part of a data file that contains information for calendar application software 340. Because events that are recorded on the calendar of employee 140 by calendar application software 340 are likely to represent activities to be recorded on employee 140's time sheet report, in embodiments of the present invention time sheet reporting application 120 is provided with such data from second data record 132.

File management software 350 may be used to manage documents/files that are created or otherwise accessed by employee 140. File management software 350 may be part of an operating system or a document management system. In some embodiments, file management software 350 keeps a record of every access made by employee 140 (or any user, for that matter) to each of a plurality of files that are being managed, such as word processor files, spreadsheet files, database files, etc. In the embodiment shown, the record of accesses by employee 140 to documents/files may be stored in third data record 133. File management software 350 may be, for example, part of an operating system executing on second computer 320, and third data record 133 may be part of a document profile maintained by file management software 350. When an employee is accessing a document (e.g., when the document has been opened by a word processor program), then it is likely that the employee is performing some activity with the document that may be recorded in the employee's time sheet report. For example, if on a Monday a document “AH Proposal.doc” was opened for four hours and six minutes by a word processor program as per a command of employee 140, and that document is associated with a proposal to be sent to the Akron Heating Company, then the time sheet for employee 140 may reflect that employee 140 was performing an activity for the Akron Heating client for 4.1 hours on that date. For this reason, in embodiments of the present invention time sheet reporting application 120 is provided with such data from third data record 133.

The two software programs stored in memory 325 are merely shown as examples, and in other embodiments different and/or additional programs may store data for employee 140, which data may be exported for use by time sheet reporting program 120. In FIG. 3, the data for the programs used by employee 140 is stored in second computer 320, but of course in other embodiments such data might be stored in a file server (not shown) to which second computer 320 is connected as part of a LAN. Data for employee 140 may be found based on a unique identifier associated with employee 140. In some embodiments, the data sheet may be prepopulated by either first computer 310, second computer 230, both computers, or neither computer.

In some embodiments, prepopulated time sheet report 106 is a spreadsheet file that is transmitted to employee 140 as an email message. When employee 140 uses second computer 320 to open this email message, prepopulated time sheet report 106 may be modified as desired to create a finalized time report, which then may be posted to time sheet database 360-n as discussed above.

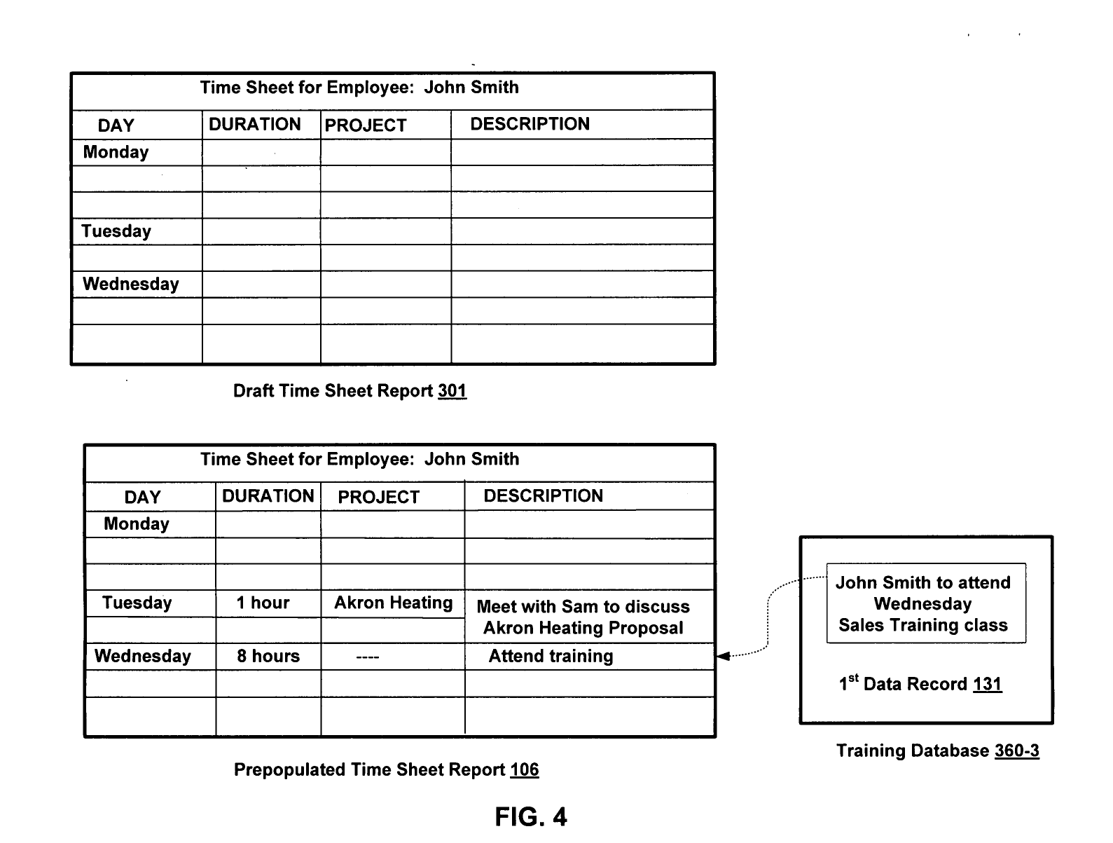

FIG. 4 is a block diagram that shows examples of different stages of time sheet reports for employee 140 that were generated according to an embodiment of the present invention. FIG. 4 shows a user view of draft time sheet report 301, a user view of prepopulated time sheet report 106, and training database 360-3. Draft time sheet report 301 and prepopulated time sheet report 106 may be formatted as spreadsheet files (e.g., .XLS files for Microsoft Excel®) or using any other known or new format. As shown, both version of the time sheet cover the employee's time on a hourly basis, including activity descriptions, duration of time spent thereon, and projects, if any, for which the activity was performed. Although shown as including three days (Monday to Wednesday), the time sheet report of course may cover an additional and/or different reporting period.

In the example shown in FIG. 4, after draft time sheet report 301 is created, it contains the employee's name (John Smith) and the days of the reporting period. Of course, other information may also be included, such an the employee's identification number, business unit, etc. In embodiments, and as discussed above, time sheet reporting application 120 may generate a query that causes information from first data record 131 to be extracted from training database 360-3 and to be imported into prepopulated time sheet report 106 as an activity. In the example shown, first data record 131 indicates that employee 140 was scheduled for an eight hour training class on Wednesday, and time sheet reporting application 120 creates an entry in prepopulated time sheet report 106 using this information. Similarly, an entry may be created in prepopulated time sheet report 106 for a one hour meeting with “Sam” from Akron Heating based on another data record in database 160-n.

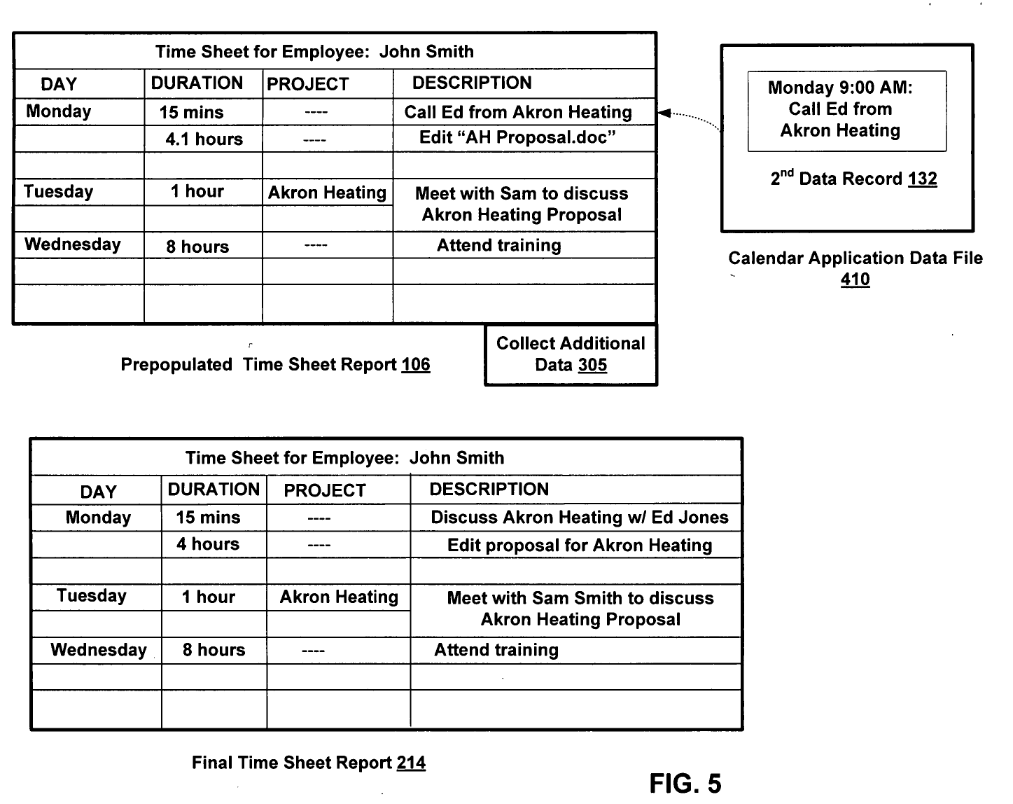

FIG. 5 is a block diagram that shows additional examples of different stages of time sheet reports that were generated according to an embodiment of the present invention. As with FIG. 4, FIG. 5 also shows a user view of prepopulated time sheet report 106, along with the two entries on Tuesday and Wednesday discussed above for FIG. 4. In addition, FIG. 5 also shows calendar application data file 410, and final time sheet report 214. In the example of FIG. 5, prepopulated time sheet report 106 contains a button labeled “collect additional data 305,” which may have been incorporated into the data file and may appear on employee application 145. When activated, such as by employee 140 after receipt of prepopulated time sheet report 106, this may cause the generation of queries (such as 107 and 109) to data records associated with second computer 320. Thus, information from calendar application data 410 (which may be a file that contains data for calendar application software 340) may be imported into prepopulated time sheet report 106 as an activity. In the example shown, second record 132 indicates that employee 140 scheduled a fifteen minute meeting for Monday, and employee application 145 thus creates an entry in prepopulated time sheet report 106 using this information.

When prepopulated time sheet report 106 is reviewed by employee 140, employee 140 may determine that the extracted data does not accurately reflect the work that the employee did during that time period. For example, the phone call to Ed from Akron Heating may not have taken place, employee 140 may not have stayed for all eight hours of the training class, employee 140 may have performed activities in addition to those shown on prepopulated time sheet report 106, etc. Employee 140 may then make corrections to prepopulated time sheet report 106 (e.g., using a spreadsheet application program) and may submit or post the final time sheet report 214. Employee 140 may also make clarifications to the information that had been imported into prepopulated time sheet report 106, such as by clarifying the wording in the description fields. Final time sheet report 214, which may also be formatted as spreadsheet file, may then be posted as shown and discussed with regard to FIG. 2.

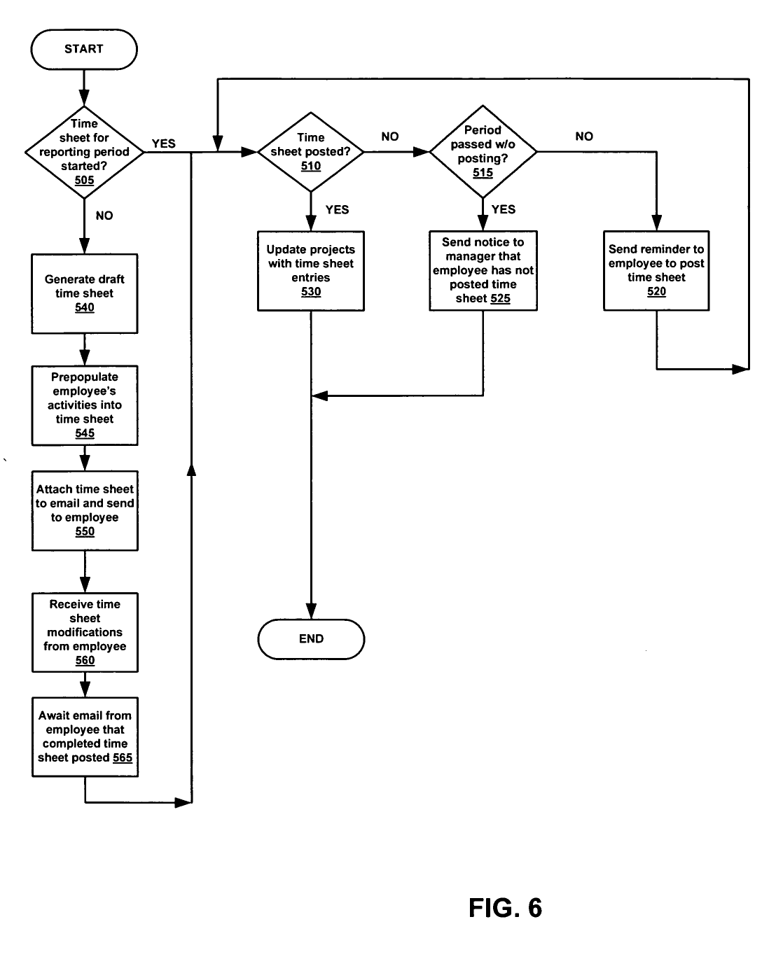

FIG. 6 is a flowchart of a method for generating a time sheet according to an embodiment of the present invention. A time sheet reporting application may determine that it is time for an employee to submit a time sheet for a reporting period. In the embodiment shown, time sheet reporting application 120 may determine whether the employee's time sheet for a given time period has been started (505). If not, time sheet reporting application 120 may generate a draft electronic time sheet report (540), for example from time sheet template 395. The draft time sheet report may be a data file formatted for a spreadsheet application program.

Time sheet reporting application 120 may automatically retrieve the employee's activities for the given time period. To do this, time sheet reporting application 120 may search data records stored on second computer 320, as well as databases 360-1 through 360-n, for activities associated with the employee's unique identifier, e.g., the employee's social security number, employee number, telephone number, email address, etc. Activities may include project work, committee meetings, client discussions, etc. Time sheet reporting application 120 may retrieve the employee's previous time sheet and use the data as the default for the newly generated time sheet. After retrieving the activities, time sheet reporting application 120 may prepopulate the blank time sheet with the retrieved activities (545). To do so, time sheet reporting application 120 may generate a query to obtain information about activities performed by the employee during a reporting period from a plurality of data records associated with different software applications. For example, the query generated may obtain schedule information from a data record associated with software that performs a calendar application, may obtain information on the employee's usage of an application data file from a data record associated with software that relates to the management of computer files, may obtain information about activities performed by the employee by searching the data records for a unique identifier of the employee, etc. Time sheet reporting application 120 may calculate an amount of employee time associated with said activities from the information, and may prepopulate the electronic time sheet report to include information obtained about the employee's activities and the amount of time spent on those activities.

Time sheet reporting application 120 may then attach the prepopulated time sheet to an email message and send the email message and attachment to the employee for review (550). Upon receipt of this email message, the employee may initiate the further prepopulation of the time sheet, such as based on locally stored data records. In some embodiments, such further prepopulation may be automatically launched, such as when the employee opens the time sheet. In addition, the employee may modify the time sheet data manually. To do this, the employee may open the time sheet (such as by using a spreadsheet application program) and change the automatically retrieved data. Time sheet reporting application 120 may receive the modified electronic time sheet report (560).

After the employee completes the time sheet, the employee may post the time sheet to time database 360-n, as discussed above. Upon posting the time sheet, an email message may be transmitted to time sheet reporting application 120 indicating that the employee has posted a completed time sheet to a time sheet database. Time sheet reporting application 120 may await such a notification (565). If time sheet reporting application 120 has generated a time sheet but has not yet received a notification of posting, time sheet reporting application 120 may determine Whether a period of time (e.g., a week) has passed since time sheet reporting application 120 transmitted the prepopulated time sheet to the employee. If this time period has not passed, time sheet reporting application 120 may send a reminder to the employee to post a completed time sheet (520). If even after sending that notification a second period of time has passed without a response, time sheet reporting application 120 may send an email notification to the employee's supervisor that the employee has not yet posted a completed time sheet (525). If time sheet reporting application 120 receives notification that the employee posted a completed time sheet, time sheet reporting application 120 may update the time sheet databases with the appropriate time sheet data (530).

The above is a detailed discussion of certain embodiments. It may be understood that the examples discussed are for illustration purposes only and are not intended to limit the configuration to that shown. It is of course intended that the scope of the claims may cover other embodiments than those described above and their equivalents.

What is claimed is:

1. A method comprising:
opening a draft electronic time sheet report for an employee;
generating a query to obtain information, from a plurality of data records associated with different software applications, about activities performed by the employee during a reporting period;
determining, from the information obtained, an amount of the employee's time that is associated with said activities; and
prepopulating the electronic time sheet report to include information obtained about the employee's activities and the amount of time associated with those activities.

2. The method of claim 1, wherein the method is executed using a spreadsheet application program.

3. The method of claim 1, wherein the method further comprises receiving a modification from the employee to at least some of the prepopulated information.

4. The method of claim 3, wherein the method further comprises posting the time sheet report to a time sheet database as a final time sheet report.

5. The method of claim 1, wherein the draft time sheet that is opened contains at least some prepopulated information about the employee's activities.

6. A method comprising:
generating a draft electronic time sheet report for an employee;
generating a query to obtain information, from a plurality of data records associated with different software applications, about activities performed by the employee during a reporting period;
determining, from the information obtained, an amount of the employee's time that is associated with said activities;
prepopulating the electronic time sheet report to include information obtained about the employee's activities and the amount of time associated with those activities; and
transmitting the prepopulated time sheet report to the employee by electronic mail.

7. The method of claim 6, wherein the electronic time sheet report is a data file formatted for a spreadsheet application program.

8. The method of claim 6, wherein the query generated is to obtain schedule information from a data record associated with software that performs a calendar function.

9. The method of claim 6, wherein the query generated is to obtain information on the employee's usage of an application data file from a data record associated with software that relates to the management of computer files.

10. The method of claim 6, wherein said generating a query comprises determining a set of software applications to query based upon a profile that is associated with the employee.

11. The method of claim 6, further comprising:
receiving a modification to the prepopulated time sheet report from the employee.

12. The method of claim 6, further comprising:
receiving a notification that the employee has posted the prepopulated time sheet report to a time sheet database.

13. The method of claim 6, further comprising:
transmitting a reminder to the employee if a notification indicating that the employee has posted the time sheet report has not been received within a first time period after the prepopulated time sheet report was transmitted to the employee; and
transmitting a notification by electronic mail to a supervisor of the employee if a notification indicating that the employee has posted the time sheet report has not been received within a second time period after the prepopulated time sheet report was transmitted to the employee.

14. A method comprising:
determining in a software program on a computer system that it is time for an employee to submit a time sheet report for a reporting period;
generating a draft electronic time sheet report for the employee;
generating a query to obtain information, from a plurality of data records that are each associated with different software applications, about activities performed by the employee during that reporting period;
determining, from the information obtained, an amount of the employee's time that is associated with said activities; and
prepopulating the electronic time sheet report to include information obtained about the employee's activities and the amount of the employee's time that is associated with those activities.

15. The method of claim 14, the method further comprising:
sending the prepopulated time sheet report to the employee by electronic mail.

16. The method of claim 15, wherein the prepopulated time sheet report is sent to the employee with software instructions for obtaining data from records on an employee computer to further prepopulate the time sheet report.

17. The method of claim 15, further comprising:
receiving a modification to the prepopulated time sheet report from the employee.

18. The method of claim 15, further comprising:
receiving a notification that the employee has posted the prepopulated time sheet report to a time sheet database.

19. The method of claim 15, wherein the prepopulated electronic time sheet report is based in part on activity information from a previous time sheet report for this employee.

20. The method of claim 14, further comprising:
sending a reminder to the employee if a notification indicating that the employee has posted the time sheet report has not been received within a time period after the prepopulated time sheet report was transmitted to the employee.
